(19) United States
(12) Patent Application Publication
(10) Pub. No.: US 2026/0293804 A1
(43) Pub. Date: Oct. 1, 2026

(54) MEASUREMENT OF VOLUME IN CLEAN GRAIN ELEVATOR

(71) Applicant: Deere & Company, Moline, IL (US)

(72) Inventors: Ryan C. RUSSELL, Orion, IL (US); Federico PARDINA-MALBRAN, Fort Collins, CO (US); Corey A. AKERS, Highlands Ranch, CO (US)

(21) Appl. No.: 19/091,314

(22) Filed: Mar. 26, 2025

(51) Int. Cl. A01D 41/127; A01D 61/00; G01F 22/00

(52) U.S. Cl. CPC A01D 41/127; A01D 61/00; G01F 22/00

(57) ABSTRACT

A sensor senses a characteristic of a pile of grain on a carrier in a clean grain elevator. The sensor generates a sensor signal indicative of the sensed characteristic. A volume detection system generates a volume output indicative of a volume of the pile of grain on the carrier based on the sensor signal. A volume processing system receives the volume output from the volume detection system and generates a yield value based upon the volume output.

### FIELD OF THE DESCRIPTION

The present description describes a portion of an agricultural harvester. More specifically, the present description describes measurement of volume of material in a clean grain elevator of an agricultural harvester.

### BACKGROUND

There are many different types of agricultural equipment. Some such agricultural equipment includes agricultural harvesters, such as combine harvesters. A combine harvester includes a header which engages crop material in a field and severs that crop material and a feeder house which moves the crop material from the header to a threshing system, a separator, and a grain cleaning system (or cleaning shoe). Clean grain is moved, by a clean grain elevator, from the grain cleaning system into a clean grain tank.

Some combine harvesters have a yield sensor that attempts to sense the yield (e.g., the amount of grain) entering the clean grain tank from the clean grain elevator. For example, some such sensors include force sensors configured so that, as grain exits the clean grain elevator and enters the clean grain tank, the grain engages the force sensor. The force sensor generates a sensor signal indicative of the force imparted on the force sensor by the grain. Based upon the sensor signal output by the force sensor, a system attempts to calculate the mass flow of grain entering the clean grain tank. The mass flow of grain entering the clean grain tank is then used to estimate yield.

The discussion above is merely provided for general background information and is not intended to be used as an aid in determining the scope of the claimed subject matter.

### SUMMARY

A sensor senses a characteristic of a pile of grain on a carrier in a clean grain elevator. The sensor generates a sensor signal indicative of the sensed characteristic. A volume detection system generates a volume output indicative of a volume of the pile of grain on the carrier based on the sensor signal. A volume processing system receives the volume output from the volume detection system and generates a yield value based upon the volume output.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a pictorial illustration of one example of a harvester.

FIGS. 2, 3, and 4 are pictorial illustrations showing different examples of carriers in a clean grain elevator in a harvester.

FIG. 5 is a block diagram of one example of a yield sensing system.

FIG. 6A shows a representation of an actual grain pile.

FIG. 6B shows a representation of the grain pile generated by sensing points on a surface of the grain pile and interpolating over the points to generate a three-dimensional (3D) contour of the surface of the grain pile.

FIGS. 7A and 7B (collectively referred to herein as FIG. 7) show a flow diagram illustrating one example of the operation of the yield sensing system.

FIG. 8 is a block diagram showing one example of the harvester in a remote server architecture.

FIGS. 9, 10, and 11 show examples of mobile devices that can be used in systems and architectures shown in other FIGs.

FIG. 12 is a block diagram of one example of a computing environment that can be used in systems and architectures shown in other FIGs.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

As discussed above, some combine harvesters have a yield sensor that attempts to sense the yield (e.g., the amount of grain) entering the clean grain tank from the clean grain elevator. For example, some such sensors include force sensors configured so that, as grain exits the clean grain elevator and enters the clean grain tank, the grain engages the force sensor. The force sensor generates a sensor signal indicative of the force imparted on the force sensor by the grain. Based upon the sensor signal output by the force sensor, a system attempts to calculate the mass flow of grain entering the clean grain tank. The mass flow of grain entering the clean grain tank is then used to estimate yield.

Many combine harvester have other types of sensors that attempt to sense the amount of grain being moved through the clean grain elevator into the clean grain tank.

The clean grain elevator often includes a set of carriers, such as buckets or paddles, that are coupled in spaced relation relative to one another along a chain or belt or other continuous member. The continuous member is driven to move the carriers upward from the cleaning system in the agricultural harvester, where each of the carriers collects a discrete pile of grain, to an outlet end of the clean grain elevator where the carriers dump the grain that they are carrying into the clean grain tank. In some combine harvesters, a force sensor is mounted at the outlet end of the clean grain elevator and positioned such that the grain that is emptied from the carriers engages the force sensor. The force sensor generates a sensor signal that is indicative of the force of the grain impacting the force sensor. Based upon the sensor signal, the amount of grain flow into the clean grain tank is estimated.

Such a sensor configuration is subject to many inaccuracies. For instance, crop characteristics may influence the sensor signal. By way of example, the crop type and crop moisture can cause the sensor signal to generate different sensor signal values, where the crop type or crop moisture is different, even though the volume of crop material impacting the sensor is the same. Further, if the agricultural harvester is traveling uphill, downhill, or along a sidehill, the grain may impact the force sensor differently than if the agricultural harvester is traveling on level terrain. Thus, even the same volume of harvested crop material will generate a different sensor signal, depending upon the orientation of the agricultural harvester.

Another current system uses a laser, beam-break type sensor in the clean grain elevator. As the carriers travel upward through the clean grain elevator, the laser sensor detects the top of the pile being carried by each carrier. The system then attempts to generate an output indicative of the amount of grain on each carrier based upon the sensor signal. However, this type of system is also subject to inaccuracies. For instance, the shape of the grain pile on each bucket or paddle may be different. Some piles may be wider or narrower than other piles. Similarly, the shape of the surface (the surface contour) of one grain pile may be different than the surface contour of another pile. Thus, even though two piles of grain, on two different carriers, have the same height, the volume of grain in the two piles may be significantly different from one another.

The present description thus proceeds with respect to a system that uses a sensor to sense a plurality of different points on a surface of a pile of grain being carried by a carrier (e.g., a paddle or bucket) in a clean grain elevator. A volume detection system then estimates a surface contour corresponding to the grain pile, based upon the plurality of sensed points. The volume detection system then generates a grain pile volume value indicative of the volume of the grain pile, based upon the surface contour of the grain pile. The present system can also process the volume value to identify an instantaneous yield value corresponding to the grain pile and/or a geo-referenced and/or time stamped yield or volume value corresponding to the grain pile. The volume values for a plurality of different grain piles can be aggregated to generate an aggregate yield value, and/or the volume value can be processed to identify a test weight corresponding to the grain.

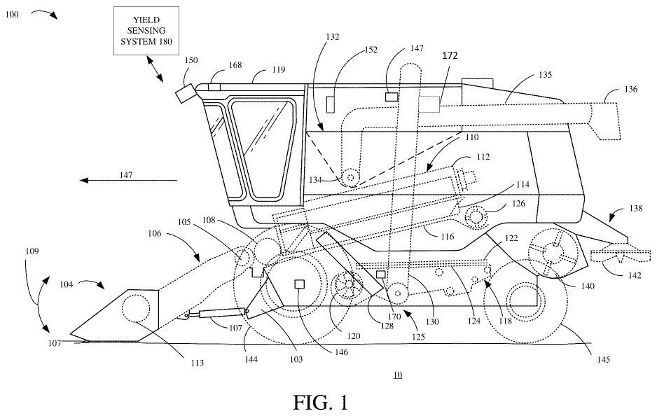

FIG. 1 is partial pictorial, partial schematic illustration of an example agricultural work machine 100 in the form of an agricultural harvester 100. In the example shown in FIG. 1, agricultural harvester 100 is in the form of a combine harvester. As illustrated in FIG. 1, harvester 100 includes ground engaging traction elements (wheels or tracks) 144 and 145 which can be driven by a propulsion subsystem (e.g., internal combustion engine, electric motor(s), hydrostatic drive, and other drivetrain elements, such as a gear box) to propel harvester 100 across a worksite 10 (e.g., a field). Harvester 100 includes an operator compartment or cab 119, which can include a variety of different operator interface mechanisms for controlling harvester 100 as well as for presenting (e.g., displaying, etc.) various information. Harvester 100 includes a feeder house 106, a feed accelerator 108, and a thresher generally indicated at 110. The feeder house 106 and the feed accelerator 108 form part of a material handling subsystem 125. Header 104 is pivotally coupled to a frame 103 of harvester 100 along pivot axis 105. One or more actuators 107 drive movement of header 104 about axis 105 in the direction generally indicated by arrow 109. Thus, a vertical position of header 104 (the header height) above ground 111 over which the header 104 travels is controllable by actuating actuator 107. While not shown in FIG. 1, agricultural harvester 100 can also include one or more actuators that operate to apply a tilt angle, a roll angle, or both to the header 104 or portions of header 104.

Agricultural harvester 100 includes a material handling subsystem 125 that includes a thresher 110 which illustratively includes a threshing rotor 112 and a set of concaves 114. Further, material handling subsystem 125 also includes a separator 116. Agricultural harvester 100 also includes a cleaning subsystem or cleaning shoe (collectively referred to as cleaning subsystem 118) that includes cleaning fan(s) 120, chaffer 122, and sieve 124. The material handling subsystem 125 also includes discharge beater 126, tailings elevator 128, and clean grain elevator 130. The clean grain elevator 130 may include a belt or chain that has carriers (such as paddles or buckets) attached thereto. As the belt or chain is driven by an actuator (such as a motor, the engine, or other actuator), the carriers lift clean grain upward through the clean grain elevator 130 and into a material receptacle (or clean grain tank) 132. Some examples of carriers in a clean grain elevator 130 are shown and discussed in greater detail below with respect to other FIGs.

Harvester 100 also includes a material transfer subsystem that includes a conveying mechanism 134 and a chute 135. Chute 135 includes a spout 136. In some examples, spout 136 can be movably coupled to chute 135 such that spout 136 can be controllably rotated to change the orientation of spout 136. Conveying mechanism 134 can be a variety of different types of conveying mechanisms, such as an auger, blower, or belted conveyor. Conveying mechanism 134 is in communication with clean grain tank 132 and is driven (e.g., by an actuator, such as motor or engine) to convey material from grain tank 132 through chute 135 and spout 136. Chute 135 is rotatable through a range of positions from a storage position (shown in FIG. 1) to a variety of deployed positions away from agricultural harvester 100 to align spout 136 relative to a material receptacle of a material receiving machine that is configured to receive the material from within grain tank 132. Spout 136, in some examples, is also rotatable, by an actuator, to adjust the direction of the material stream exiting spout 136.

Harvester 100 also includes residue subsystem 138. Residue handling subsystem 138 can include chopper 140 that chops residue and spreader 142 that spreads the residue on the field 10 behind harvester 100.

In some examples, a harvester within the scope of the present disclosure can have more than one of any of the subsystems mentioned above. In some examples, harvester 100 can have left and right cleaning subsystems, separators, etc., which are not shown in FIG. 1.

In operation, and by way of overview, harvester 100 illustratively moves through field 10 in the direction indicated by arrow 147. As harvester 100 moves, header 104 engages the crop plants to be harvested and cuts, with a cutter bar 107 on the header 104, the crop plants to generate cut crop material.

The cut crop material is engaged by a cross conveyor (e.g. cross auger, belts, etc.) 113 which conveys the severed crop material to a center of the header 104 where the severed crop material is then moved through an opening to a conveyor in feeder house 106 toward feed accelerator 108, which accelerates the severed crop material into thresher 110. The severed crop material is threshed by rotor 112 rotating the crop against concaves 114. The threshed crop material is moved by a separator rotor in separator 116 where a portion of the residue is moved by discharge beater 126 toward the residue subsystem 138. The portion of residue transferred to the residue subsystem 138 is chopped by residue chopper 140 and spread on the field by spreader 142. In other configurations, the residue is released from the agricultural harvester 100 in a windrow.

Grain falls to cleaning subsystem 118. Chaffer 122 separates some larger pieces of MOG from the grain, and sieve 124 separates some finer pieces of MOG from the grain. The grain then falls to a conveyor (e.g., an auger, etc.) that moves the grain to an inlet end of grain elevator 130, and the grain elevator 130 moves the grain upwards, depositing the grain in grain tank 132. Residue is removed from the cleaning subsystem 118 by airflow generated by one or more cleaning fans 120. Cleaning fans 120 direct air along an airflow path upwardly through the sieves and chaffers. The airflow carries residue rearwardly in harvester 100 toward the residue handling subsystem 138.

Tailings elevator 128 returns tailings to thresher 110 where the tailings are re-threshed. Alternatively, the tailings also can be passed to a separate re-threshing mechanism by a tailings elevator or another transport device where the tailings are re-threshed as well.

Harvester 100 can include a variety of sensors, some of which are illustrated in FIG. 1, such as ground speed sensor 146, one or more pile sensors 147, geographic position sensor 168, carrier speed sensor 170, carrier position sensor 172, one or more observation sensors 150, and one or more fill level sensors 152.

Ground speed sensor 146 senses the travel speed of harvester 100 over the ground. Ground speed sensor 146 can sense the travel speed of the harvester 100 by sensing the speed of rotation of the ground engaging traction elements 144 or 145, or both, a drive shaft, an axle, or other components. Ground speed sensors 146 can also include direction sensors such as a compass, a magnetometer, a gravimetric sensor, a gyroscope, GPS derivation, to determine the direction of travel in two or three dimensions in combination with the speed. Thus, when harvester 100 is on a slope, the orientation of harvester 100 relative to the slope is known. For example, an orientation of harvester 100 could include ascending, descending, or transversely travelling the slope.

Geographic position sensor 168 can sense the position of harvester 100 in a local or global coordinate system. Geographic position sensor 168 can thus be a global positioning system (GPS), a dead reckoning system, a long-range navigation (LORAN) system, a Doppler speed sensor, or a wide variety of other systems or sensors that provide an indication of the geographic location of harvester 100. Geographic position sensors 168 can also include a real-time kinematic (RTK) component that is configured to enhance the precision of position data derived from the GNSS signal. In some instances, the travel speed of harvester 100 can be sensed using the output of geographic position sensor 168 as well.

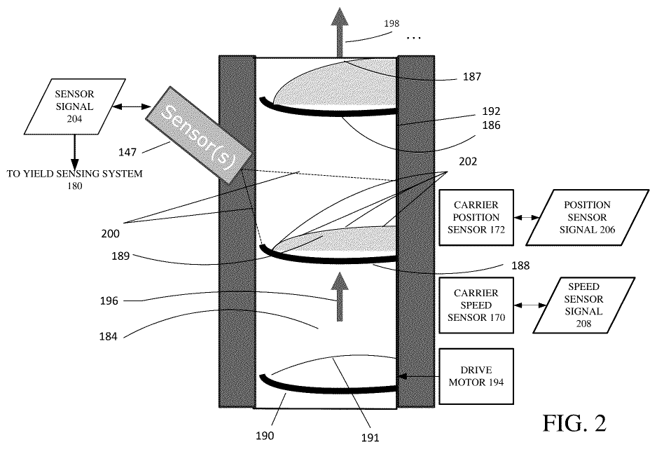

Pile sensors 147 are mounted in or relative to clean grain elevator 130 to sense points on the surface of grain piles being carried by the carriers within clean grain elevator 130 as the grain piles move up the clean grain elevator 130. Some examples of the placement of such sensors 147 are illustrated below with respect to FIGS. 2-4. Sensors 147 can take a wide variety of different forms, such as RADAR sensors, LIDAR sensors, proximity sensors, distance sensors, near infrared (NIR) sensors, as well as various other sensors configured to emit and/or receive electromagnetic radiation, among a wide variety of other sensors. The sensor signals generated by pile sensors 147 are provided to yield sensing system 180 which can use the sensor signals to generate a representation of a surface contour or topography of the piles being sensed. That surface contour or topography is used to generate a volume value indicating a volume of each of the piles. In some examples, the volume values are used in the calculation of yield as well as in the calculation of the fill level of the on-board material tank 132, in the calculation of test weight, or for other calculations or control operations.

Observation sensor systems 150 can include one or more of a variety of sensors, such as cameras (e.g., mono cameras, stereo cameras, color (e.g. RGB) cameras, multispectral cameras, etc.), LIDAR sensors, RADAR sensors, ultrasonic sensors, as well as various other sensors configured to emit and/or receive electromagnetic radiation, as well as a variety of other sensors. Observation sensor systems 150 can illustratively observe (and thus detect characteristics relative to) the worksite 10, items at the worksite 10 (e.g., vegetation, including crops at the worksite), and portions of the harvester 100. While FIG. 1 shows some example positions of observation sensor system 150, it will be understood that observation sensor systems 150 can, alternatively or additionally, be positioned (or otherwise disposed) at a variety of other locations on harvester 100.

Fill level sensors 152 can include one or more of a variety of sensors, such as contact sensors and non-contact sensors. Fill level sensors 152 detect a fill level of grain in grain tank 132. Fill level sensors 152, in the form of contact sensors, include paddles (or other contact members) that are contacted by the grain and the displacement of the contact members or force or load of impact of the material on the contact member can be detected to determine presence of grain material at the level of the tank corresponding to the sensor. Fill level sensors 152, in the form of non-contact sensors, can be configured to capture electromagnetic radiation to detect presence of grain at the level of the tank corresponding to the sensor. In some examples, fill level sensors 152 are configured to alert an operator when the clean grain tank 132 on harvester 100 is full (or is approaching full). These are merely some examples. While FIG. 1 shows some example positions of fill level sensors 152, it will be understood that fill level sensors 152 can, additionally or alternatively, be positioned (or otherwise disposed) at a variety of other locations on harvester 100.

Carrier speed sensor 172 can sense the speed at which the carriers in clean grain elevator 130 are traveling upward to dump their grain into clean grain tank 132. In one example, the carriers are connected to a chain or belt or other continuous member that is driven by a drive motor for rotation about a set of pulleys. Thus, carrier speed sensor 170 can sense the speed of rotation of the output of the motor driving the chain or belt or other continuous member. In another example, carrier speed sensor 170 can detect the speed of movement of the carriers by detecting the presence of carriers as they pass sensor 170 and a time between detected carriers (with a known carrier geometry and distance separating the carriers), or using an encoder on the chain, belt, or other continuous member in the clean grain elevator 130. Carrier speed sensor 172 can sense carrier speed using other sensors as well.

Carrier position sensor 172 illustratively generates an output indicative of the position of a carrier relative to the position of pile sensor(s) 147. The position of the carriers relative to the position of pile sensor(s) 147 can be sensed using an encoder on the chain or belt or other continuous member that is being driven to move the carriers. The encoder may generate an output indicative of the relative position of the chain or belt or continuous member relative to the pile sensor(s) 147. In another example, the position of the carriers relative to the pile sensor(s) 147 can be generated by directly detecting a carrier and its position, by using a known geometry (e.g., carrier spacing) along with the speed at which the carriers are moving and a time since the last carrier was detected, in order to derive a position of a carrier relative to pile sensor(s) 147.

FIG. 2 is a pictorial illustration of one example of a portion of clean grain elevator 130 (e.g., with a portion of the housing of clean grain elevator 130 cut away). In the example shown in FIG. 2, clean grain elevator 130 is defined by a wall or housing 182 which defines an interior 184 of clean grain elevator 130. A set of carriers 186, 188, 190 are attached to a belt or chain or other continuous member 192 which may be driven by a drive motor 194. For example, it may be that continuous member 192 is rotatable about a set of pulleys and drive motor 194 drives rotation of continuous member 192 about the pulleys so that continuous member 192 moves carriers 186-190 in the direction indicated by arrows 196 and 198. FIG. 2 shows that each carrier 186, 188, and 190 is carrying a corresponding grain pile 187, 189, and 191. In one example, carriers 186, 188, and 190 are continuously driven upward in the direction indicated by arrows 196 and 198 until each carrier reaches an outlet and of clean grain elevator 130 where the carriers 186, 188 and 190 rotate over an upper pulley to dump or otherwise empty grain piles 187, 189, and 191, carried by carriers 186, 188 and 190, into clean grain tank 132.

In FIG. 2, grain pile sensor 147 may be a stereo camera or other vision sensor (such as a RADAR sensor, a LIDAR sensor, proximity sensor, a distance sensor, a near infrared pair (NIR) sensor or other sensor) that has a field-of-view indicated by dashed lines 200. Sensor 147 senses a plurality of points 202 on the surface of pile 189, as pile 189 passes through the field-of-view 200. Sensor 147 generates a sensor signal 204 indicative of a location of sensed points 202 (e.g., indicative of a point cloud defined by points 202 or indicative of a distance of points 202 from a reference point-such as the distance from sensor 147) and provides that sensor signal to yield sensing system 180. In addition, carrier position sensor 172 senses the position of carrier 188 relative to the position of pile sensor 147 and provides a sensor signal 206 indicative of that position to yield sensing system 180. Carrier speed sensor 170 generates a speed sensor signal 208 indicative of the speed at which carrier 188 is traveling in the direction indicated by arrows 196 and 198 and provides that speed sensor signal 208 to yield sensing system 180 as well. Based upon the location of points 202 relative to the location of carrier 188, yield sensing system 180 can estimate a surface contour or topography of grain pile 189 and can also generate an output indicative of the volume of grain pile 189. Thus, the volume of each grain pile, carried by each carrier, as that grain pile passes sensor 147, can be detected and used for yield sensing or used in other ways.

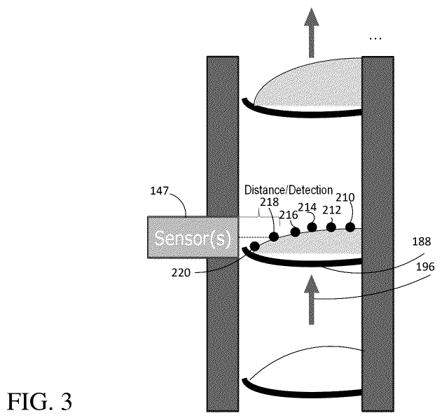

FIG. 3 is similar to FIG. 2, and similar items are similarly numbered. In the example shown in FIG. 3, sensor 147 is a distance sensor which senses the distance between sensor 147 and the point on the surface of pile 189 that is sensed by sensor 147. For instance, as carrier 188 moves upward in the direction indicated by arrow 196, sensor 147 will first sense point 210 on the top of pile 189. As carrier 188 continues to move upward, sensor 147 will then begin sensing successive points 212, 214, 216, 218, and 220 until carrier 188 passes upward out of the field-of-view of sensor 147. The sensor signal 204 generated by sensor 147 in the example shown in FIG. 3 will thus indicate the location of points 210-220 (e.g., the distance that those points are from sensor 147). By knowing the speed at which carrier 188 is moving, and by knowing the geometry of carrier 188, and the position of carrier 188 relative to sensor 147, yield sensing system 180 can generate or estimate the surface contour or topography of pile 189. That surface contour or topography can then be used to calculate the volume of pile 189.

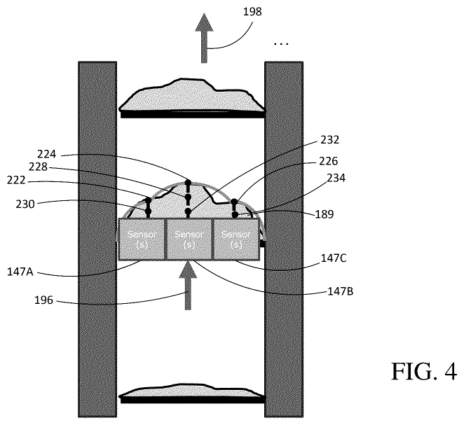

FIG. 4 is similar to FIGS. 2 and 3 and similar items are similarly numbered. However, FIG. 4 shows that sensors 147 include an array of sensors one 147A, 147B, and 147C disposed about a portion of an interior periphery of clean grain elevator 130. Each sensor 147A-147C may be a distance sensor which senses the distance of one or more points on the surface of pile 189 from the corresponding sensor. Thus, sensors 147A-147C may sense the distance of a plurality of points from the top of pile 189 to the bottom of pile 189, as pile 189 moves past the field-of-view of the sensors. As an example, as pile 189 moves in the direction indicated by arrows 196 and 198, sensor 147B will first sense point 224, and provide a sensor signal indicating the distance that point 224 lies from sensor 1407B. Then, as pile 189 continues to move upward, sensors 147A-147C will sense points 222, 228, and 226, respectively, and provide corresponding sensor signals indicating how far those sensed points are from the corresponding sensors. As pile 189 continues to move upwardly, sensors 147A-147C will continue to sense points (such as points 230, 232, and 234, respectively) on pile 189. Points 222-234 can thus be used by yield sensing system 180 to interpolate over those points to generate an output indicative of the surface contour or topography of pile 189. That surface contour or topography can again be used to identify the volume of pile 189.

It will be noted that the example shown in FIGS. 2-4 are examples only and a wide variety of other sensor configurations and sensor placements relative to clean grain elevator 130 can be used.

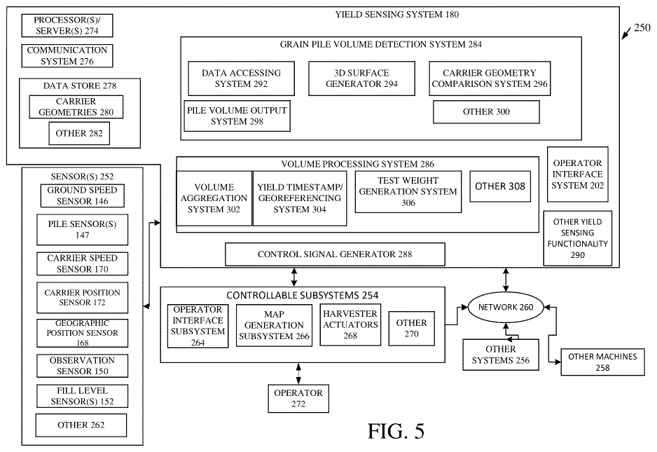

FIG. 5 is a block diagram of one example of an agricultural system 250 in which yield sensing system 180 is shown in more detail. FIG. 5 also shows that, in agricultural system 250, yield sensing system 180 receives one or more inputs from sensors 252 (which may be sensors described elsewhere herein or other sensors 262) and can generate outputs to controllable subsystems 254, other systems 256, and other machines 258, over network 260.

In one example, network 260 may be a wide area network, a local area network, a cellular communication network, a Wi-Fi or Bluetooth network, a near field communication network, or any of a variety of other networks or combinations of networks. Also, in one example, other machines 258 can include tender vehicles, maintenance vehicles, other harvesters, or still other machines. Other systems 256 may be farm manager systems, systems in remote server environments, or other systems. Controllable subsystems 254 can include operator interface subsystem 264, map generation subsystem 266, one or more harvester actuators 268, and/or any of a wide variety of other subsystems 270.

Operator interface subsystem 264 can generate interfaces for, and receive inputs from, operator 272. Operator interface subsystem 264 can include operator interface mechanisms that can be used by operator 272 in operator compartment 119 to control and manipulate harvester 100. Therefore, those operator interface mechanisms can include joysticks, a steering wheel, peddles, levers, linkages, buttons, etc. Further, the operator interface mechanisms can include a display screen that displays information to the operator 272 and that receives inputs from operator 272 through operator actuatable input mechanisms such as links, icons, buttons, etc. The display screen may be a touch sensitive screen where the operator interface mechanisms can be actuated using touch gestures. Further, operator interface subsystem 264 can include a microphone and speaker where speech recognition and speech synthesis are provided and can include a wide variety of other mechanisms that provide audio, visual, and/or haptic outputs to an operator 272 and/or receive inputs from an operator 272.

Map generation subsystem 266 can receive geo-referenced yield values from yield sensing system 180 and generate a yield map. The yield map may provide geo-referenced yield values that map the yield values identified by yield sensing system 180 to geographic locations in the field being harvested.

Harvester actuators 268 can include any of the actuators discussed above with respect to FIGS. 1-4, or still other actuators on harvester 100. The actuators can be used to control the subsystems on harvester 100 or to control other items on harvester 100. Actuators 268 can be hydraulic actuators, electric actuators, pneumatic actuators, and/or any of wide variety of other actuators.

FIG. 5 shows that, in one example, yield sensing system 180 includes one or more processors or servers 274, communication system 276, data store 278 (which can include carrier geometries 280 and other items 282), grain pile volume detection system 284, volume processing system 286, control signal generator 288, and other yield sensing functionality 290. Grain pile volume detection system 284 can include data accessing system 292, three-dimensional (3D) surface generator 294, carrier geometry comparison system 296, pile volume output system 298, and other items 300. Volume processing system 286 can include volume aggregation system 302, yield timestamp/geo-referencing system 304, test weight generation system 306, and other items 308. Before describing the operation of yield sensing system 180 in more detail, a description of some of the items in yield sensing system 180, and their operation, will first be provided.

Communication system 276 illustratively facilitates communication among the items in yield sensing system 180 with one another, with sensors 252, controllable subsystems 254, and communication over network 260. Therefore, communication system 276 can be a controller area network (CAN) bus and bus controller, a cellular communication system, a wide area network communication system, a local area network communication system, a Bluetooth and/or Wi-Fi communication system, a near field communication system, or other systems or combinations of systems.

Carrier geometries 280 can define the geometry of the different carriers 186, 188, 190, etc. in the clean grain elevator 130. The carrier geometries 280 may include data that defines the spacing between the carriers 186-190, the size and shape of the carriers 186-190, among other things.

Grain pile volume detection system 284 receives inputs from one or more sensors 252 and may access carrier geometries 280 and generate an output indicative of the volume of grain carried by each carrier, after that carrier is sensed by sensor 147. Data accessing system 292 can access carrier geometries 280 and receive and condition sensor signals from sensors 252. Data accessing system 292 can thus perform signal amplification, filtering, aggregation, normalization, and/or other signal conditioning functions on the sensor signals to obtain conditioned sensor signals. 3D surface generator 294 receives data from pile sensors 147 identifying the location of points on the surface of a grain pile. 3D surface generator 294 may also receive the carrier speed from carrier speed sensor 170, the carrier position from carrier position sensor 172, and/or other information. 3D surface generator 294 then generates an output indicative of the surface contour or topography of the grain pile being processed. For instance, by knowing the position of the carrier relative to the sensor 147, and by receiving a set of sensed points on the surface of the pile (e.g., a point cloud indicative of points on the surface of the grain pile carried by the carrier), 3D surface generator 294 can interpolate and smooth across the points to generate an output indicative of the surface contour of the grain pile. Carrier geometry comparison system 296 then compares the location of the surface of the grain pile (as output by 3D surface generator 294) to the location and geometry of the carrier that is supporting that grain pile. The comparison between the surface of the grain pile and the location of the carrier provides an output indicative of the content of the grain pile. Pile volume output system 298 then identifies the volume of the grain pile and generates an output indicative of that volume.

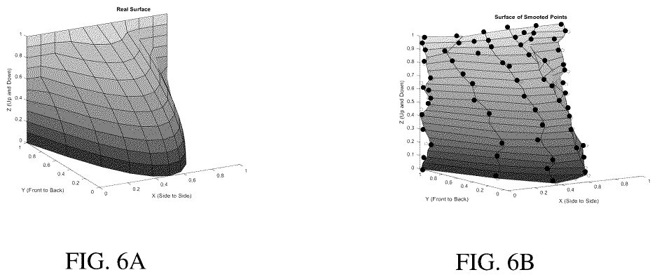

FIG. 6A shows one example of a representation of a real surface contour of a grain pile, in a 3-axis coordinate system, assuming that the carrier supporting the grain pile is located on the axis in a plane where Z=0. It can be seen that the grain pile extends above the carrier in a range of Z=0 to Z=1, and the grain pile extends from side to side along the X axis from X=0 to X=1. Further, the grain pile extends along the Y axis from Y=0 to Y=1.

FIG. 6B shows an example in which a point cloud of points, represented by the small dots in FIG. 6B, are sensed by one or more pile sensors 147. 3D surface generator 294 obtains an indication of the points represented by the dots and interpolates and smooths a three-dimensional surface over those points. Carrier geometry comparison system 296 then identifies the location and geometry of the carrier (e.g., the top surface of the carrier is represented by the plane Z=0 in FIG. 6B) to identify the content of the grain pile (above the carrier). Pile volume output system 298 performs a volume calculation to compute the volume of the grain pile above the carrier.

In one example, system 292, generator 294, system 296, and system 298 can be computing systems and/or processors that execute rules-based algorithms or other algorithms that can be used to generate a 3D surface, compare that surface against another surface defined by the carrier to identify the pile content, and estimate volume of the pile content. Generator 294 and systems 296 and 298 can be machine learning models, computer-aided design (CAD)-based models, artificial neural networks, or other models that generate surface contours based upon points, lines, meshes, shapes, or other types of systems.

Volume processing system 286 receives the volume output from pile volume output system 298, which is indicative of the volume of a particular grain pile, and may perform additional processing on that volume to identify other values. For instance, volume aggregation system 302 can aggregate the volumes of a plurality of different grain piles to identify the amount of grain that enters the clean grain tank (by summing the volume carried by each carrier over time). Yield timestamp/geo-referencing system 304 can provide a timestamp corresponding to each volume measurement and/or a geo-referencing value corresponding to each volume measurement. The timestamp values can be used to identify instantaneous yield which may be indicated by the volume of grain carried by a particular carrier at a particular timestamp. The timestamp may also be used to identify the geographic location from which the grain was harvested (e.g., given a known delay between engagement of the crop by the header 104 and when the crop passes pile sensors 147). Test weight generation system 306 can be used to generate a test weight for the harvested grain. The test weight may be a volumetric weight of the grain in each pile or in an aggregated number of piles to obtain a desired measure of test weight (e.g., pounds per bushel, etc.). The test weight may be calculated based on the measured volume of grain carried by each carrier as well as the measured weight (e.g., where the grain is weighed as it enters the clean grain tank, or where the grain is weighed subsequently—such as by load cells in a grain cart or by another scale in the harvesting operation).

Control signal generator 288 can receive inputs from volume processing system 286, grain pile volume detection system 284, and/or any of a variety of other systems and generate control signals to control one or more controllable subsystems 254. Control signal generator 288 can generate control signals to control operator interface subsystem 264 to generate outputs for operator 272 indicative of yield or any of the other values calculated by volume processing system 286 or other information. Control signal generator 288 can generate control signals to control map generation subsystem 266 to generate a yield map or other map. Control signal generator 288 can also generate control signals to control any of the harvester actuators 268 or harvester functionality discussed with respect to other FIGs. Control signal generator 288 can also generate control signals to control communication system 276 to communicate information to other systems 256 or other machines 258. Control signal generator 288 can generate other control signals as well.

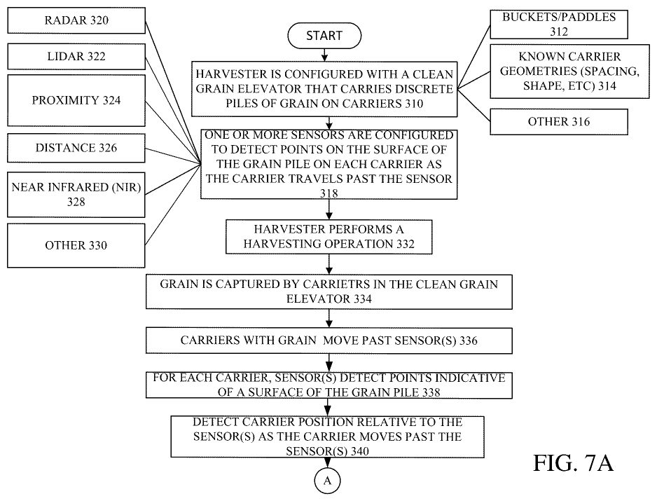

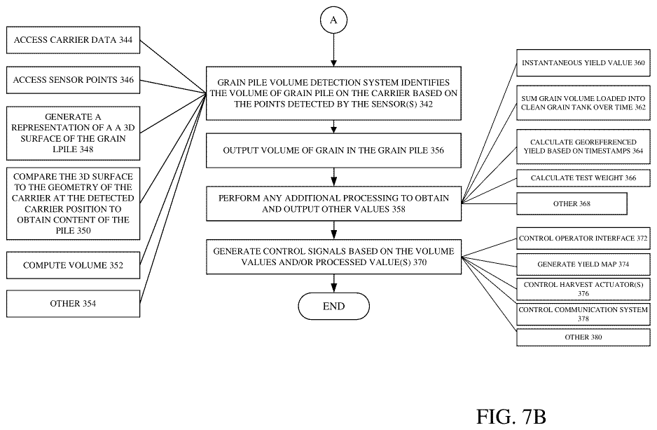

FIGS. 7A and 7B (collectively referred to herein as FIG. 7) show a flow diagram illustrating one example of the operation of the agricultural system 250 shown in FIG. 5. It is first assumed that harvester 100 is configured with a clean grain elevator 130 that carries discrete piles of grain on carriers into the clean grain tank 132. Having harvester 100 configured in this way as indicated by block 310 in the flow diagram illustrated in FIG. 7. In one example, the carriers are buckets or paddles 312 and the carrier geometries 280 are known and accessible by yield sensing system 180, as indicated by block 314 and the flow diagram of FIG. 7. Harvester 100 can be configured in other ways as well, as indicated by block 316.

One or more sensors 147 are configured to detect points or other characteristics on the surface of grain piles on each carrier as the carrier travels past the one or more sensors 147. Having sensors 147 configured in this way is indicated by block 318 in the flow diagram of FIG. 7. It should be noted that sensors 318 can be configured to detect a point cloud of data, a distance that the detected point on the pile is spaced from the sensor 147, or other characteristics of the surface of the grain pile. Sensors 147 can include RADAR sensors 320, LIDAR sensors 322, proximity sensors 324, other distance sensors 326, near infrared (NIR) sensors 328, and/or any of a wide variety of other sensors 330.

Harvester 100 then begins performing a harvesting operation, as indicated by block 332. During the harvesting operation, grain is captured by the carriers and the clean grain elevator 130, as indicated by block 334. The carriers with grain move past pile sensors 147, as indicated by block 336.

For each carrier, sensors 147 detect one or more points indicative of the surface of the grain pile, as the grain pile moves past the sensor 147. Detecting surface points is indicated by block 338. In one example, carrier position sensor 172 also detects the carrier position relative to sensors 147, as the carrier moves past the sensors 147. Detecting the carrier position is indicated by block 340.

Grain pile volume detection system 284 then detects the volume of the grain pile on the carrier based upon the points detected by the pile sensor(s) 147. Identifying the volume of the grain pile is indicated by block 342 in the flow diagram of FIG. 7. In one example, data accessing system 292 accesses the carrier data (e.g., the carrier speed, the carrier position, the carrier geometries 280, etc.) as indicated by block 344. Data accessing system 292 can also access the sensor points detected by pile sensor(s) 147, as indicated by block 346.

3D surface generator 294 then generates a 3D surface of the grain pile, based upon the carrier data and the sensor points, as indicated by block 348. Carrier geometry comparison system 296 compares the 3D surface to the geometry of the carrier to obtain a representation of the content of the grain pile, as indicated by block 350. For example, carrier geometry comparison system 296 can identify the content of the grain pile as the portion from the 3D surface down to the upper surface of the carrier (such as the Z=0 plane in FIG. 6B). Pile volume output system 298 then computes the volume of the grain pile (such as by running a volume estimation algorithm or applying a volume computation model or in other ways) based upon the representation of the content of the grain pile, as indicated by block 352. The volume of the grain pile can be identified in other ways as well, as indicated by block 354.

Pile volume output system 298 then outputs the volume of the grain in the grain pile carried by the carrier, as indicated by block 356. Volume processing system 286 can then perform any additional processing to obtain and output other values, as indicated by block 358. For instance, yield timestamp/geo-referencing system 304 can generate an output based upon the volume of each carrier indicative of an instantaneous yield value at the corresponding timestamp or geo-reference value. Generating an instantaneous yield value is indicated by block 360. Volume aggregation system 302 can sum the volume of the grain piles loaded into the clean grain tank 132 over time to identify a volumetric flow rate of the grain or to identify an overall volume of grain added to the clean grain tank 132. Summing the volume of the grain piles is indicated by block 362. Yield timestamp/geo-referencing system 304 can also generate timestamps and/or geo-reference values for aggregate volumes that are summed or otherwise aggregated by volume aggregation system 302, as indicated by block 364. Test weight generation system 306 can calculate the test weight corresponding to the grain being harvested, as indicated by block 366. Volume processing system 286 can perform any of a wide variety of other processing to generate other values based upon the volume of the grain piles carried by the carriers in the clean grain elevator, as indicated by block 368.

One or more of the values generated by grain pile volume detection system 284 and/or volume processing system 286 can be provided to control signal generator 288 which generates control signals based upon those inputs. Generating control signals is indicated by block 370 in the flow diagram of FIG. 7. The control signals can be used to control operator interface subsystem 264, as indicated by block 372, to control map generation subsystem 266 to generate a yield map, as indicated by block 374, to control harvest actuators as indicated by block 376, to control communication subsystem 276, as indicated by block 378, and/or to control any of a wide variety of other controllable subsystems 270, as indicated by block 380.

It can thus be seen that the present description describes a system that accurately senses a volume of a grain pile being carried by each of the carriers in clean grain elevator 130. Points on the surface of each grain pile are sensed, and a 3D surface contour or topography of the grain pile is identified. The grain pile volume is computed based upon the 3D surface contour or topography. Additional processing can be performed on the volume values corresponding to the grain piles to generate outputs such as yield instantaneous yield, aggregate yield, georeferenced yield, test weight, overall grain volume, etc. Various subsystems can be controlled based upon those values.

The present discussion has mentioned processors and servers. In one example, the processors and servers include computer processors with associated memory and timing circuitry, not separately shown. The processors or servers are functional parts of the systems or devices to which they belong and are activated by and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays the mechanisms has speech recognition components, the mechanisms can be actuated using speech commands.

A number of data stores have also been discussed. It will be noted the data stores can each be broken into multiple data stores. All can be local to the systems accessing the data stores, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components, generators, and/or logic. It will be appreciated that such systems, components, generators, and/or logic can be comprised of hardware items (such as processors and associated memory, or other processing components, some of which are described below) that perform the functions associated with those systems, components, generators, and/or logic. In addition, the systems, components, generators, and/or logic can be comprised of software that is loaded into a memory and is subsequently executed by a processor or server, or other computing component, as described below. The systems, components, generators, and/or logic can also be comprised of different combinations of hardware, software, firmware, etc., some examples of which are described below. These are only some examples of different structures that can be used to form the systems, components, generators, and/or logic described above. Other structures can be used as well.

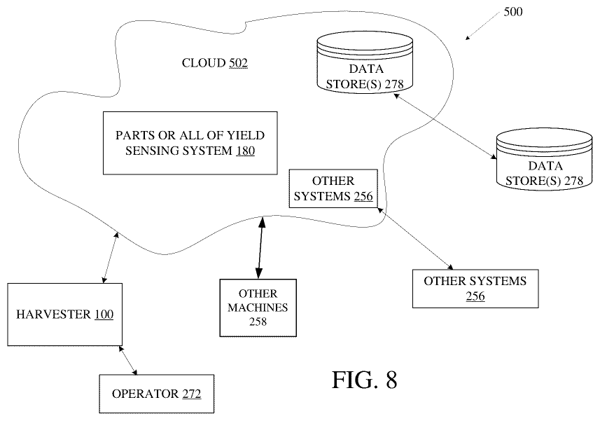

FIG. 8 is a block diagram of harvester 100, shown in FIG. 1, except that it communicates with elements in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network, and they can be accessed through a web browser or any other computing component. Software or components shown in previous FIGS. as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, the components and functions can be provided from a conventional server, or they can be installed on client devices directly, or in other ways.

In the example shown in FIG. 8, some items are similar to those shown in previous FIGS. and they are similarly numbered. FIG. 8 specifically shows that part or all of yield sensing system 180, data store 278, and/or other systems 256 can be located at a remote server location 502. Therefore, harvester 100 accesses those systems through remote server location 502.

FIG. 8 also depicts another example of remote server architecture. FIG. 8 shows that it is also contemplated that some elements of previous FIGS are disposed at remote server location 502 while others are not. By way of example, data store 278 and/or other systems 256 can be disposed at a location separate from location 502, and accessed through the remote server at location 502. Regardless of where the items are located, they can be accessed directly by harvester 100, through a network (either a wide area network or a local area network), the items can be hosted at a remote site by a service, or the items can be provided as a service, or accessed by a connection service that resides in a remote location. Also, the data can be stored in substantially any location and intermittently accessed by, or forwarded to, interested parties. All of these architectures are contemplated herein.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

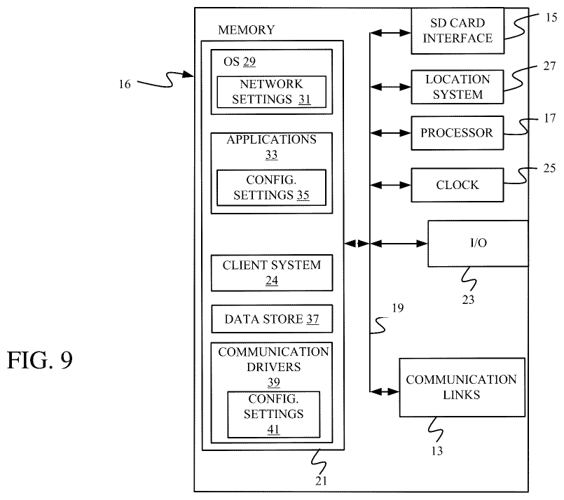

FIG. 9 is a simplified block diagram of one illustrative example of a handheld or mobile computing device that can be used as a user's or client's handheld device 16, in which the present system (or parts of it) can be deployed. For instance, a mobile device can be deployed in the operator compartment of harvester 100 for use in generating, processing, or displaying the volume or yield data. FIGS. 9-11 are examples of handheld or mobile devices.

FIG. 9 provides a general block diagram of the components of a client device 16 that can run some components shown in previous FIGS., that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

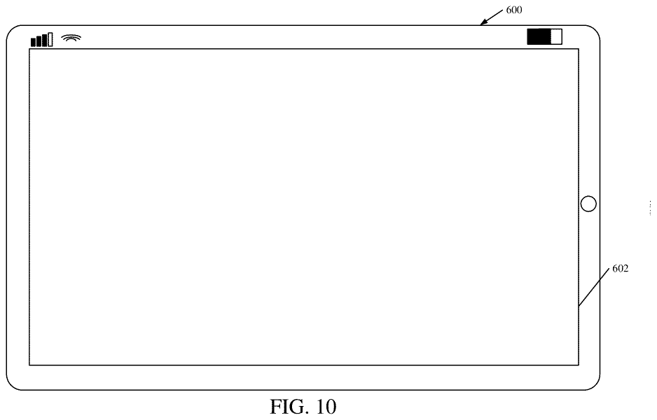

FIG. 10 shows one example in which device 16 is a tablet computer 600. In FIG. 10, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

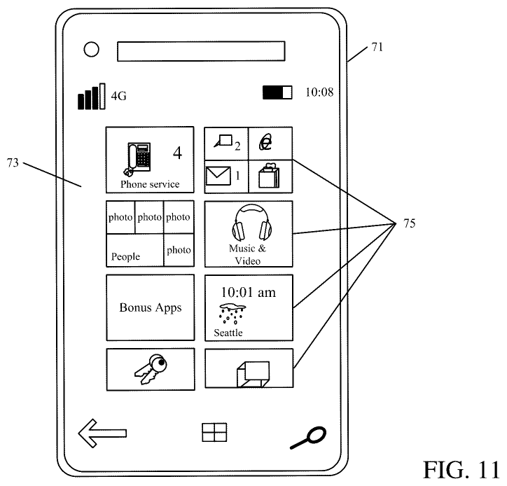

FIG. 11 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

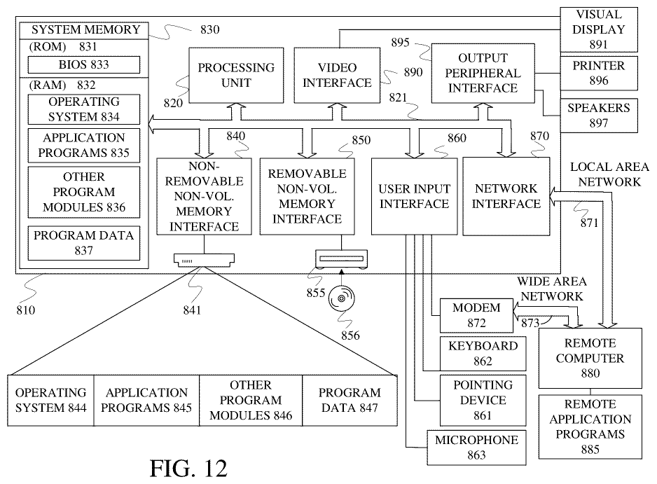

FIG. 12 is one example of a computing environment in which elements of previous FIGS., or parts of it, (for example) can be deployed. With reference to FIG. 12, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 12.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random-access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates operating system 834, application programs 835, other program modules 836, and program data 837.

The computer 810 may also include other removable/non-removable volatile/nonvolatile computer storage media. By way of example only, FIG. 12 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 12, provide storage of computer readable instructions, data structures, program modules and other data for the computer 810. In FIG. 12, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network—CAN, local area network—LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 12 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method comprising:
detecting a set of points on a surface of a pile of material carried by a carrier through a clean grain elevator of an agricultural harvester;
computing a volume of material in the pile based on the set of points; and
generating a control signal based on the computed volume of material.

2. The computer implemented method of claim 1, wherein detecting the set of points comprises:
detecting a distance from a reference point to each point in a first plurality of points in the set of points, using a first detector, as the pile of material is carried by the carrier through a field of view of the first detector.

3. The computer implemented method of claim 2, wherein detecting the set of points comprises:
detecting a distance from a reference point to each point in a second plurality of points in the set of points, using a second detector, as the pile of material is carried by the carrier through a field of view of the second detector.

4. The computer implemented method of claim 2, wherein detecting the set of points comprises:
detecting a speed of travel of the carrier.

5. The computer implemented method of claim 4, wherein computing the volume comprises:
generating a representation of a three-dimensional (3D) surface contour of the pile of material based on the first plurality of points and the speed of travel of the carrier; and
computing the volume based on the representation of the 3D surface contour.

6. The computer implemented method of claim 5, wherein computing the volume comprises:
accessing a carrier geometry corresponding to the carrier; and
computing the volume based on the representation of the 3D surface contour of the pile and the carrier geometry.

7. The computer implemented method of claim 6, wherein the carrier geometry identifies a location of the carrier relative to the representation of the 3D surface contour of the pile and wherein computing the volume based on the representation of the 3D surface contour of the pile and the carrier geometry comprises:
comparing the representation of the 3D surface contour to the location of the carrier relative to the representation of the 3D surface contour to obtain a shape of the pile of material; and
computing the volume based on the shape of the pile of material.

8. The computer implemented method of claim 2 and further comprising:
identifying an instantaneous yield value corresponding to the pile of material based on the volume.

9. The computer implemented method of claim 2 and further comprising:
detecting a weight corresponding to the pile of material; and
identifying a test weight corresponding to the pile of material based on the weight and the volume.

10. The computer implemented method of claim 1 and further comprising:
generating a geographic reference value corresponding to the volume.

11. The computer implemented method of claim 10, wherein generating the control signal comprises:
generating a mapping control signal to control a map generation system to generate a map based on the volume and the geographic reference value corresponding to the volume.

12. An agricultural system comprising:
a pile sensor configured to detect a set of points on a surface of a pile of material carried by a carrier through a clean grain elevator of an agricultural harvester;
a pile volume detection system configured to identify a volume of material in the pile based on the set of points; and
a control signal generator configured to generate a control signal based on the computed volume of material.

13. The agricultural system of claim 12, wherein the pile sensor comprises:
a first detector having a first field of view and mounted relative to the clean grain elevator to detect a distance from a reference point to each point in a first plurality of points in the set of points as the pile of material is carried by the carrier through the first field of view; and
a second detector having a second field of view and mounted relative to the clean grain elevator to detect a distance from a reference point to each point in a second plurality of points in the set of points as the pile of material is carried by the carrier through the second field of view.

14. The agricultural system of claim 13 and further comprising:
a carrier speed sensor configured to detect a speed of travel of the carrier through the clean grain elevator.

15. The agricultural system of claim 14, wherein the pile volume detection system comprises:
a three-dimensional (3D) surface generator configured to generate a representation of a 3D surface contour of the pile of material based on the first plurality of points and second plurality of points and the speed of travel of the carrier; and
a pile volume output system configured to identify the volume of material based on the representation of the 3D surface contour.

16. The agricultural system of claim 15, wherein pile volume detection system comprises:
a data accessing system configured to access a carrier geometry corresponding to the carrier, the carrier geometry identifying a location of the carrier relative to the representation of the 3D surface contour of the pile; and
a carrier geometry comparison system configured to compare the representation of the 3D surface contour to the location of the carrier relative to the representation of the 3D surface contour to obtain a shape of the pile of material, wherein the pile volume output system is configured to identify the volume of material based on the shape of the pile of material.

17. The agricultural system of claim 13 and further comprising:
a volume processing system configured to identify an instantaneous yield value corresponding to the pile of material based on the volume of material.

18. The agricultural system of claim 12 and further comprising:
a weight detector configured to detect a weight corresponding to the pile of material; and
a test weight generation system configured to identify a test weight corresponding to the pile of material based on the weight and the volume of material.

19. The agricultural system of claim 12 and further comprising:
a georeferencing system configured to generate a geographic reference value corresponding to the volume of material, wherein the control signal generator is configured to generate a mapping control signal to control a map generation system to generate a map based on the volume of material and the geographic reference value corresponding to the volume of material.

20. An agricultural harvester comprising:
a header configured to engage crop;
a crop processing subsystem configured to process the crop;
a clean grain tank;
a clean grain elevator having a continuous member and a plurality of carriers coupled in spaced relation to one another along the continuous member, each carrier being configured to carry a discrete pile of harvested material to the clean grain tank;
a pile sensor configured to detect a set of points on a surface of each discrete pile of harvested material; and
a volume detection system configured to compute a volume of harvested material in the pile based on the set of points.
